(19) United States
(12) Patent Application Publication
(10) Pub. No.: US 2026/0044333 A1
(43) Pub. Date: Feb. 12, 2026

(54) HARD DISK DEVICE, FIRMWARE UPDATE PROGRAM, AND FIRMWARE UPDATE METHOD

(71) Applicants: Kabushiki Kaisha Toshiba, Tokyo (JP); Toshiba Electronic Devices & Storage Corporation, Tokyo (JP)

(72) Inventors: Motoki TAKAHASHI, Yokohama Kanagawa (JP); Osamu YOSHIDA, Kawasaki Kanagawa (JP)

(21) Appl. No.: 19/064,299

(22) Filed: Feb. 26, 2025

(30) Foreign Application Priority Data
Aug. 7, 2024 (JP) 2024-130785

(51) Int. Cl. G06F 8/65

(52) U.S. Cl. CPC G06F 8/65

(57) ABSTRACT

A hard disk device includes a storage unit and a control unit. The control unit is able to perform a reception step, an update step, an initialization range identifying step, and an initialization executing step. The initialization range identifying step is a step of identifying an initialization range of control information. The initialization executing step is a step of executing initialization of the control information in the initialization range when there is the initialization range. The updated firmware includes an identification table indicating the initialization range. The initialization range identifying step is a step of identifying the initialization range on the basis of the identification table.

### CROSS-REFERENCE TO RELATED APPLICATION

This application is based upon and claims the benefit of priority from Japanese Patent Application No. 2024-130785, filed Aug. 7, 2024; the entire contents of which are incorporated herein by reference.

### FIELD

An embodiment described herein relates generally to a hard disk device, a firmware update program, and a firmware update method.

### BACKGROUND

A hard disk device stores program codes called firmware in a nonvolatile memory. The firmware is periodically updated with an updated version which is provided by a manufacturer of the hard disk device. In general, when firmware is updated, initialization of control information of the firmware is performed.

### BRIEF DESCRIPTION OF THE DRAWINGS

FIG. 1 is a conceptual diagram showing a configuration of a hard disk device according to an embodiment.

FIG. 2 is a diagram showing a sequence diagram showing a flow of updating firmware in the hard disk device according to the embodiment.

FIG. 3 is a flowchart showing a firmware update method in the hard disk device according to the embodiment.

FIG. 4 is a diagram showing an identification table of a first example in the hard disk device according to the embodiment.

FIG. 5 is a diagram showing an identification table of a second example in the hard disk device according to the embodiment.

FIG. 6 is a diagram showing an identification table of a third example in the hard disk device according to the embodiment.

### DETAILED DESCRIPTION

A hard disk device according to an embodiment includes a storage unit and a control unit. The storage unit stores firmware and control information of the firmware. The control unit operates the firmware on the basis of the control information. The control unit is able to perform a reception step, an update step, an initialization range identifying step, and an initialization executing step. The reception step is a step of receiving updated firmware from a computer. The update step is a step of updating existing firmware with the updated firmware. The initialization range identifying step is a step of identifying an initialization range of the control information. The initialization executing step is a step of executing initialization of the control information in the initialization range when there is the initialization range. The updated firmware includes an identification table indicating the initialization range. The initialization range identifying step is a step of identifying the initialization range on the basis of the identification table.

A firmware update program according to an embodiment is a program for updating firmware stored in a storage unit of a hard disk device. The firmware update program causes a control unit of the hard disk device to perform a reception step, an update step, an initialization range identifying step, and an initialization executing step. The reception step is a step of receiving updated firmware from a computer. The update step is a step of updating existing firmware with the updated firmware. The initialization range identifying step is a step of identifying an initialization range of the control information of the firmware stored in the storage unit. The initialization executing step is a step of executing initialization of the control information in the initialization range when there is the initialization range. The updated firmware includes an identification table indicating the initialization range. The initialization range identifying step is a step of identifying the initialization range on the basis of the identification table.

A firmware update method according to an embodiment is a method of updating firmware stored in a storage unit of a hard disk device. The firmware update method includes a reception step, an update step, an initialization range identifying step, and an initialization executing step. The reception step is a step of receiving updated firmware from a computer. The update step is a step of updating existing firmware with the updated firmware. The initialization range identifying step is a step of identifying an initialization range of the control information of the firmware stored in the storage unit. The initialization executing step is a step of executing initialization of the control information in the initialization range when there is the initialization range. The updated firmware includes an identification table indicating the initialization range. The initialization range identifying step is a step of identifying the initialization range on the basis of the identification table.

Hereinafter, a hard disk device, a firmware update program, and a firmware update method according to an embodiment will be described with reference to the accompanying drawings.

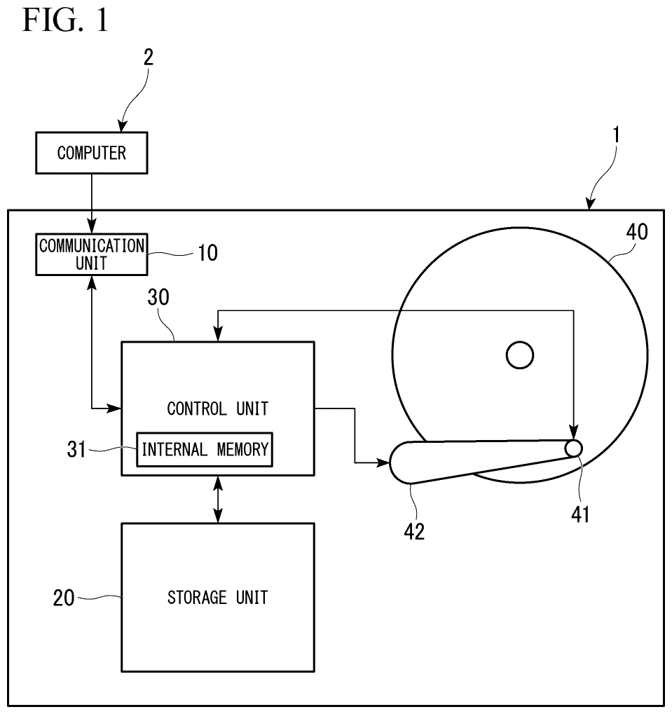

FIG. 1 is a conceptual diagram showing a configuration of a hard disk device 1 according to an embodiment. The hard disk device 1 according to the present embodiment is connected to a computer 2. The hard disk device 1 includes a communication unit 10, a storage unit 20, a control unit 30, a magnetic disk 40, a head 41, and an actuator 42.

The communication unit 10 is connected to the computer 2. The communication unit 10 performs data communication with the computer 2 using a predetermined communication protocol.

The storage unit 20 is constituted, for example, by a nonvolatile memory (NVRAM). The storage unit 20 stores firmware and control information of the firmware. Firmware is software that is installed to basically control the hard disk device 1. The control information is various types of data that are used in the firmware.

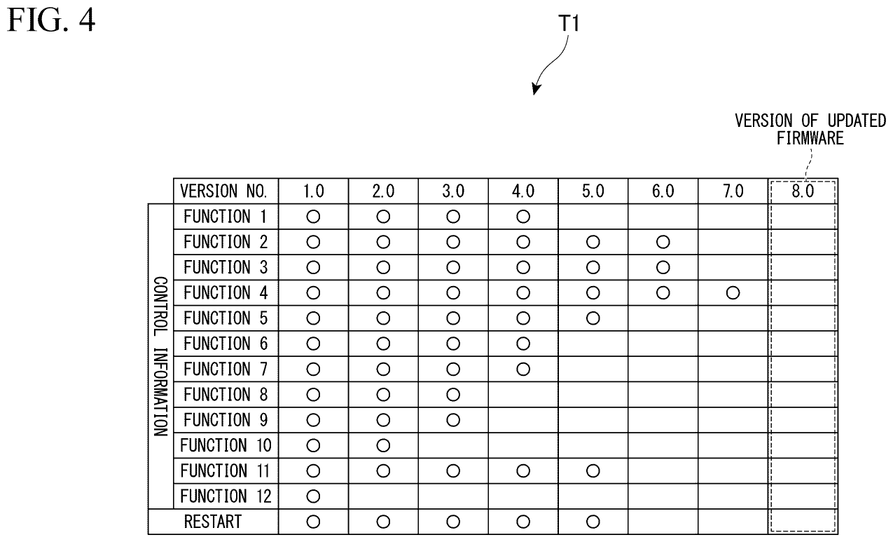

The control information includes a plurality of functions (functions 1 to 12) which will be described later (see FIG. 4). The plurality of functions included in the control information include, for example, frequency settings for data delivery with respect to the magnetic disk 40, control parameters and control programs of the actuator 42, information of sizes and structures of control tables of a system, and information of versions or model names of firmware. Among these, the information of versions or model names of firmware is an example of control information of which initialization with update is unnecessary.

The magnetic disk 40 is a disc-shaped storage medium in which a magnetic thin film is formed on a substrate and stores various types of data such as user data and control data. The head 41 performs reading and writing of data with respect to the magnetic disk 40. The actuator 42 moves the head 41 with a control current which is output from a driver of a control unit.

The control unit 30 includes an internal memory 31 that stores programs defining various process sequences and control data and performs various processes using the internal memory. The control unit 30 accesses the storage unit 20 and reads data and programs required for various processes. The control unit 30 operates firmware on the basis of control information stored in the storage unit 20. In addition, the control unit 30 can receive or transmit data from and to the computer 2 via the communication unit 10. The control unit 30 controls the actuator 42 and performs reading and writing of data via the head 41.

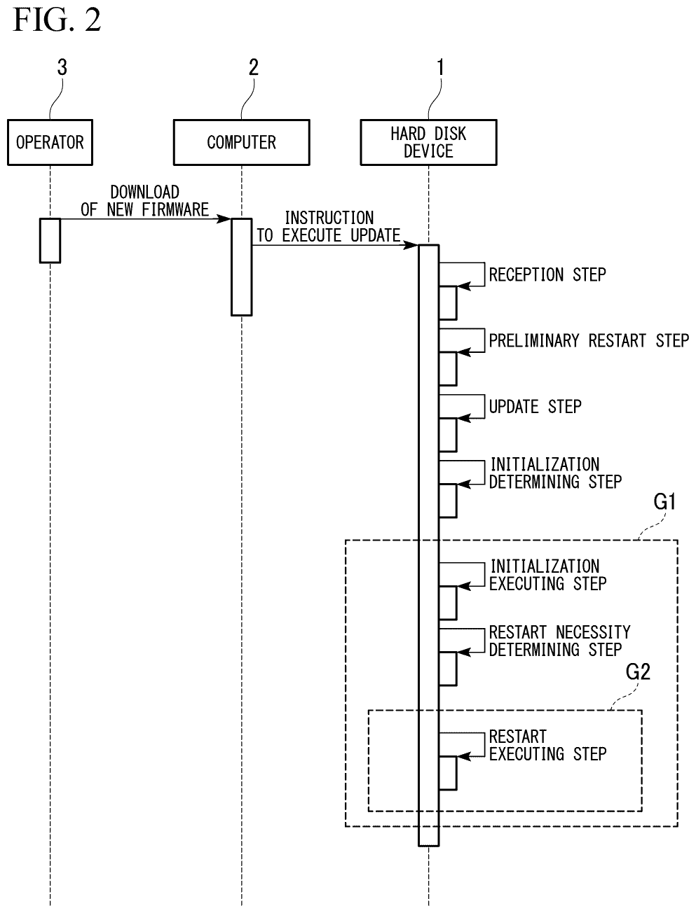

FIG. 2 is a diagram showing a flow of a series of operations that are performed by an operator 3, the computer 2, and the hard disk device 1 at the time of updating firmware of the hard disk device 1 according to the present embodiment.

Updated firmware in the present embodiment is downloaded to the computer 2 by the operator 3. Downloading of updated firmware may be performed by allowing the operator 3 to directly operate a computer or to remotely operate a computer via a network.

The operator 3 operates the computer 2 such that the hard disk device 1 is instructed to execute updating of firmware. Accordingly, the control unit 30 of the hard disk device 1 starts updating of firmware.

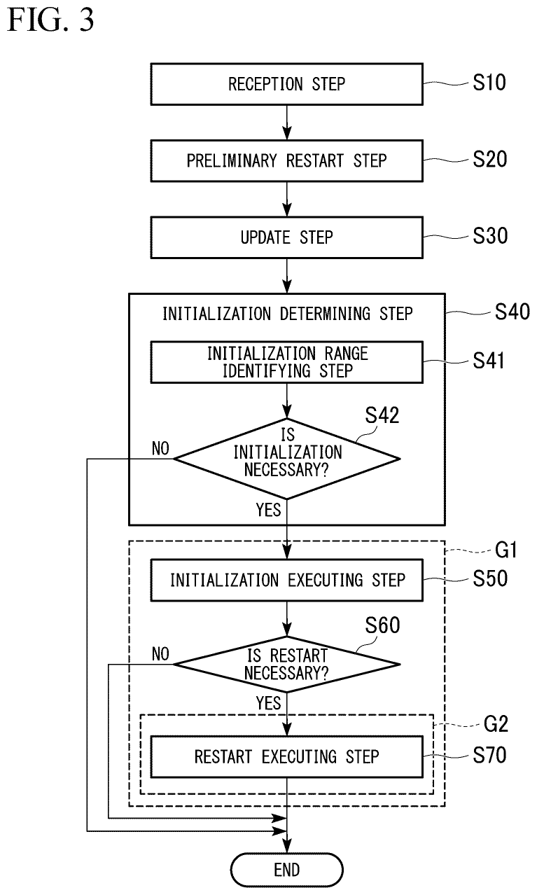

FIG. 3 is a flowchart showing a process flow of a firmware update method that is performed by the hard disk device 1. A firmware update program causes the control unit 30 to perform a reception step S10, a preliminary restart step S20, an update step S30, an initialization determining step S40, an initialization executing step S50, a restart necessity determining step S60, and a restart executing step S70. The initialization determining step S40 includes an initialization range identifying step S41 and an initialization necessity determining step S42. That is, the firmware update program causes the control unit 30 to perform the initialization range identifying step S41 and the initialization necessity determining step S42. That is, the control unit 30 according to the present embodiment can perform the aforementioned steps S10, S20, S30, S40, S41, S42, S50, S60, and S70. The firmware update method according to the present embodiment includes the aforementioned steps S10, S20, S30, S40, S41, S42, S50, S60, and S70.

The order of the steps in the firmware update program according to the present embodiment can change as long as the functions of the steps can be completed, but is not limited to the present embodiment.

The reception step S10 is a step of receiving updated firmware from a computer. The control unit 30 communicates with the computer 2 via the communication unit 10 and receives updated firmware from the computer 2. In the reception step S10, the control unit 30 stores the received updated firmware in the internal memory 31.

The preliminary restart step S20 is a step of internally restarting the hard disk device 1. In the preliminary restart step S20, firmware of the hard disk device 1 is restarted without powering off the hard disk device 1, and the update step S30 is prepared for. Accordingly, the preliminary restart step S20 needs to be performed before the update step S30.

The update step S30 is a step of updating existing firmware with updated firmware. In the update step S30, the control unit 30 installs the updated firmware stored in the internal memory 31 in the storage unit 20.

The initialization determining step S40 is a step of determining whether initialization of the control information in a certain range is necessary through updating of firmware. The initialization determining step S40 includes the initialization range identifying step S41 and the initialization necessity determining step S42. In the initialization determining step S40, the control unit 30 first performs the initialization range identifying step S41 and then performs the initialization necessity determining step S42. In the initialization necessity determining step S42, the result of the initialization range identifying step S41 is referred to.

The initialization range identifying step S41 is a step of identifying an initialization range of control information. In the initialization range identifying step S41, an identification table included in the updated firmware is used. FIG. 4 shows an identification table T1 of a first example included in the updated firmware according to the present embodiment.

In the initialization range identifying step S41, the control unit 30 first acquires version information of existing firmware from the existing firmware. Then, the control unit 30 identifies the initialization range on the basis of the version information of the existing firmware and the identification table T1.

As shown in FIG. 4, the updated firmware in the present embodiment is 8.0-version firmware (version 8.0). As shown in FIG. 4, initialization ranges of versions (versions 1.0 to 7.0) previous to the version of the updated firmware are described in the identification table T1 according to the present embodiment.

The firmware in the present embodiment operates on the basis of the control information of functions 1 to 12. In the firmware, initialization of the control information in a particular range out of the control information of functions 1 to 12 is necessary according to association with updated program codes. The identification table T1 indicates an initialization range for each version of the existing firmware. In the identification table T1 shown in FIG. 4, areas with “o” are areas (initialization ranges) requiring initialization. The control unit 30 stores functions with “o” in a column corresponding to each version of the existing firmware in the identification table T1 as an initialization range in the internal memory 31.

For example, when the version No. of the existing firmware is 5.0, the control information of functions 2, 3, 4, 5, and 11 is identified as the initialization range. In this case, for example, program codes of parts associated with the control information of functions 2, 3, 4, and 11 in the existing firmware of version 5.0 are updated in the updated firmware of version 8.0. In this way, in the identification table T1, information indicating what range of the control information in the version of the existing firmware is to be updated when the existing firmware is updated with the updated firmware is described.

The identification table T1 is used to verify an area requiring initialization for each version of the existing firmware out of updated parts of the program codes of the updated firmware and is provided along with the updated firmware. Here, the control information included in the initialization range is not limited to the control information which is used in operations associated with the updated program codes. For example, even when only the control information of functions 2 and 3 is associated with the updated program codes, it may be preferable to initialize functions 4, 5, and 11 along with initialization of functions 2 and 3 depending on update details of the program codes. Initialization of control information less associated with the program codes is known at the first time through verification of a provider and it is difficult to determine such initialization through comparison between updated program codes. In the present embodiment, since the identification table T1 is provided by the provider of the updated firmware and is guaranteed by the provider, a problem due to omission of initialization is less likely to occur.

In the present embodiment, the initialization ranges of the versions of the existing firmware are described in the identification table T1 in preparation for a case in which the existing firmware has the same version (version 8.0) as the updated firmware. In the identification table T1 of the first example, “o” is not assigned to all the functions in the column of version 8.0. Accordingly, when the version of the updated firmware is the same as the version of the existing firmware (version 8.0), it can be determined that initialization is not necessary. Even when the version of the existing firmware is the same as the version of the updated firmware (version 8.0), initialization of some (or all) control information may be necessary depending on details of the updated firmware. In this case, the initialization range is identified similarly to the case in which firmware with another version is updated, and initialization of the initialization range is necessary.

In the present embodiment, the initialization range identifying step S41 is performed after the update step S30, but the timing at which the initialization range identifying step S41 is performed is not limited to the present embodiment as long as it is performed after the reception step S10 in which the identification table T1 can be referred to and before the initialization necessity determining step S42 and the initialization executing step S50. For example, the initialization range identifying step S41 may be performed after the reception step S10 and before the update step S30.

The initialization necessity determining step S42 is a step of determining whether initialization is necessary on the basis of whether there is the initialization range identified in the initialization range identifying step S41. As described above, when the version of the existing firmware is version 5.0, the initialization range of the control information is identified as functions 2, 3, 4, 5, and 11. That is, in this case, since there is the initialization range, it is determined in initialization necessity determining step S42 that initialization necessity is “YES,” the process flow proceeds to the initialization executing step S50. It is assumed herein that the version of the existing firmware is version 5.0. However, in the first example shown in FIG. 4, when the version of the existing firmware is one of versions 1.0 to 7.0, “o” is assigned to at least one function in the column of the table, and thus it is determined that initialization necessity is “YES” (initialization necessity determining step S42: YES).

When there is no initialization range (for example, when the existing firmware has the same version (version 8.0) as the updated firmware), the control unit 30 determines that initialization necessity is “NO” in the initialization necessity determining step S42 (initialization necessity determining step S42: NO). In this case, the initialization executing step S50, the restart necessity determining step S60, and the restart executing step S70 are omitted, and the process flow associated with firmware update ends. Here, the initialization executing step S50, the restart necessity determining step S60, and the restart executing step S70 are called a first omission group G1. That is, when it is determined in the initialization necessity determining step S42 that initialization necessity is “NO,” the control unit 30 omits the steps in the first omission group G1. According to the present embodiment, when initialization of all control information is unnecessary, an operation time associated with firmware update can be saved by omitting execution of initialization and restart.

The initialization executing step S50 is performed when it is determined in the initialization necessity determining step S42 that there is an initialization range. The initialization executing step S50 is a step of executing initialization of the control information in the initialization range identified in the initialization range identifying step S41.

For example, when the version of the existing firmware is version 5.0, the control unit 30 executes initialization of functions 2, 3, 4, 5, and 11 in all the control information, and omits initialization of functions 1, 6, 7, 8, 9, 10, and 12. Accordingly, in comparison with a case in which all the control information (functions 1 to 12) is initialized, the time required for completion of the initialization executing step S50 is reduced.

The restart necessity determining step S60 is a step of determining whether restart of the hard disk device 1 is necessary after the initialization executing step S50. In the restart necessity determining step S60, the identification table T1 of the first example shown in FIG. 4 is used.

In the restart necessity determining step S60, the control unit 30 first acquires the version information of the existing firmware from the existing firmware. Then, the control unit 30 determines whether restart is necessary on the basis of the version information of the existing firmware and the identification table T1.

As shown in FIG. 4, the identification table T1 indicates whether restart is necessary for each version of the existing firmware. In the identification table T1, when “o” is assigned to the box of restart in the column of the version of the existing firmware, it is determined that restart necessity of the firmware is “YES” (restart necessity determining step S60: YES). With the identification table T1 of the first example shown in FIG. 4, when the version of the existing firmware ranges from version 1.0 to version 5.0, it is determined that restart necessity of the hard disk device 1 is “YES,” and the process flow proceeds to the restart executing step S70.

In the identification table T1, when “o” is not assigned to the box of restart in the column of the version of the existing firmware, it is determined that restart necessity of the firmware is “NO” (restart necessity determining step S60: NO). With the identification table T1 of the first example shown in FIG. 4, when the version of the existing firmware ranges from version 6.0 to version 8.0, it is determined that restart necessity is “NO,” the restart executing step S70 is omitted, and the process flow associated with firmware update ends. Here, the restart executing step S70 is referred to as a second omission group G2. That is, when it is determined in the restart necessity determining step S60 that restart necessity is “NO,” the control unit 30 omits the steps in the second omission group G2. The step (the restart executing step S70) in the second omission group G2 may be included in the first omission group G1.

The restart executing step S70 is performed when it is determined in the restart necessity determining step S60 that there is an initialization range. The restart executing step S70 is a step of executing restart of the hard disk device 1. According to the present embodiment, when restart is unnecessary, execution of restart is omitted, and thus it is possible to further save an operation time.

As shown in FIG. 2, the firmware update program according to the present embodiment causes the control unit 30 to automatically perform the aforementioned series of steps S10, S20, S30, S40, S41, S42, S50, S60, and S70. According to the present embodiment, an operator 3 has only to operate the computer 2 to execute update of the hard disk device 1, and can complete update of firmware in the hard disk device 1 without performing any additional operation. Accordingly, in comparison with a case in which the operator 3 separately performs instruction of initialization and instruction of restart, it is possible to reduce a burden of the operator 3 and to shorten the time until completion of the operation.

In the flowchart shown in FIG. 3 according to the present embodiment, when it is determined that initialization necessity is “NO” (initialization necessity determining step S42: NO), it is automatically determined that restart necessity is “NO,” and the restart executing step S70 is omitted. However, regardless of necessity of initialization, the necessity of restart may be ascertained using the identification table T1. In this case, when it is determined in the initialization necessity determining step S42 that initialization necessity is “NO,” the control unit 30 omits only the initialization executing step S50 and performs the restart necessity determining step S60.

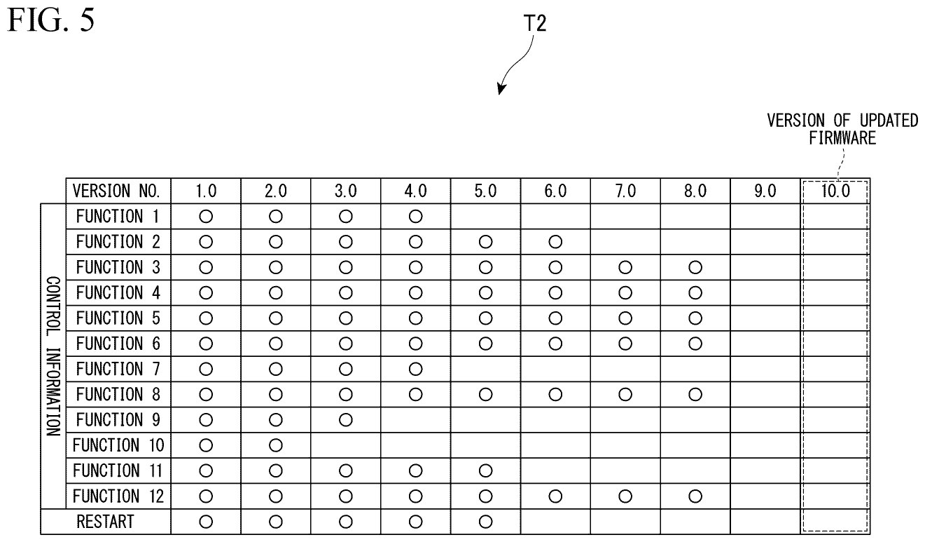

FIG. 5 shows an identification table T2 of a second example. The identification table T2 of the second example is included in the firmware of version 10.0, and is used to update the existing firmware with the firmware of version 10.0 as updated firmware.

First, it is assumed that the version of the existing firmware is version 5.0. In the identification table T2 of the second example, “o” is assigned to the boxes of functions 2, 3, 4, 5, 6, 8, 11, and 12 in the column of version 5.0. Accordingly, when the version of the existing firmware is version 5.0, the control unit 30 executes initialization of functions 2, 3, 4, 5, 6, 8, 11, and 12 in the whole control information in the initialization executing step S50 and omits initialization of functions 1, 7, 9, and 10. In the identification table T2 of the second example, “o” is assigned to the box of restart in the column of version 5.0. Accordingly, when the version of the existing firmware is version 5.0, restart of the hard disk device 1 is executed in the restart executing step S70. As described above, when the existing firmware of version 5.0 is updated with the updated firmware of the version including the identification able T2 of the second example, it is possible to omit some of control information to be initialized. Accordingly, in comparison with an update process according to the related art in which the whole control information is initialized and restart is additionally executed after the firmware has been updated, it is possible to shorten the time required for update.

Then, it is assumed that the version of the existing firmware is version 9.0. In the identification table T2 of the second example, “o” is not assigned to the boxes of all the functions in the column of version 9.0. Accordingly, when the version of the existing firmware is version 9.0, it can be determined that initialization is not necessary, and the initialization executing step S50 can be omitted. In the identification table T2 of the second example, “o” is not assigned to the box of restart in the column of version 9.0. Accordingly, when the version of the existing firmware is version 9.0, restart is not necessary, and the restart executing step S70 can also be omitted. As described above, when the existing firmware of version 9.0 is updated with the updated firmware of the version including the identification able T2 of the second example, it is possible to omit initialization and restart. Accordingly, in comparison with an update process according to the related art in which the whole control information is initialized and restart is additionally executed after the firmware has been updated, it is possible to greatly shorten the time required for update.

Then, it is assumed that the version of the existing firmware is version 11.0. As described above, the identification able T2 of the second example shown in FIG. 5 is used to update the existing firmware with firmware of version 10.0 as the updated firmware. Accordingly, the case in which the version of the existing firmware is version 11.0 is a case in which the firmware is downgraded to an older version.

In the initialization range identifying step, the control unit 30 compares the version information of the existing firmware with the version information of the updated firmware and identifies that the version (version 11.0) of the existing firmware is newer than the version (version 10.0) of the updated firmware. When it is identified that the version (version 11.0) of the existing firmware is newer than the version (version 10.0) of the updated firmware, the control unit 30 sets the initialization range such that the whole control information is included in the initialization range. The control unit 30 performs initialization of the whole control information (functions 1 to 12) in the initialization executing step S50. When it is determined that the version (version 11.0) of the existing firmware is newer than the version (version 10.0) of the updated firmware, the control unit 30 determines that the restart necessity is “YES” in the restart necessity determining step S60 and executes restart of the hard disk device 1 in the restart executing step S70. In this case, even when downgrade of the firmware is performed, it is possible to smoothly perform update with high reliability.

Here, when the firmware of the hard disk device 1 is downgraded, the version information is compared between the existing firmware and the updated firmware, and it is identified whether the version (version 11.0) of the existing firmware is newer than the version (version 10.0) of the updated firmware. However, the control unit 30 may not necessarily compare the version of the existing firmware and the updated firmware. For example, when the version of the existing firmware is not included in the identification table T2, the control unit 30 may identify that the version (version 11.0) of the existing firmware is newer than the version (version 10.0) of the updated firmware and set the initialization range such that the whole control information is included in the initialization range.

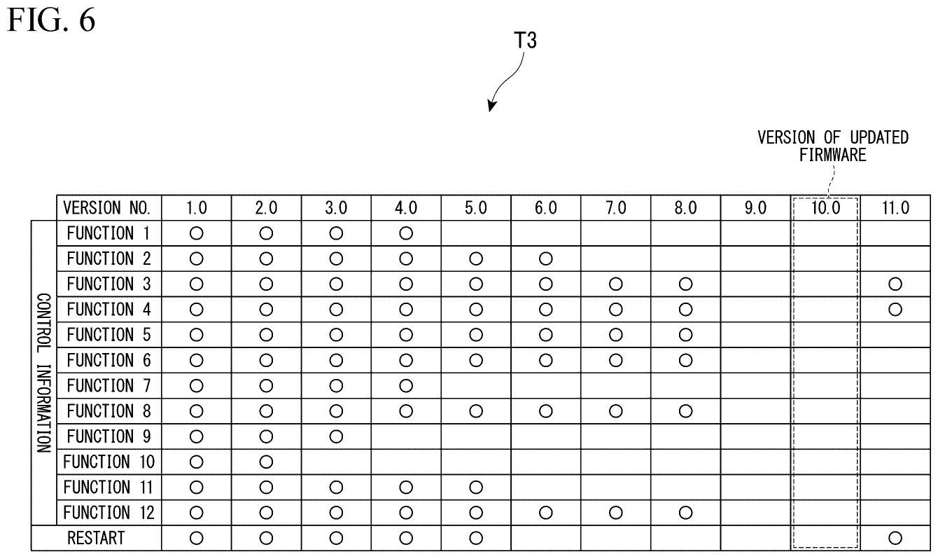

FIG. 6 shows an identification table T3 of a third example. It is assumed that the identification table T3 of the third example is included in the firmware of version 10.0 and is used to update the existing firmware with the firmware of version 10.0 as the updated firmware. Here, it is assumed that the existing firmware of version 11.0 is updated with the updated firmware of version 10.0 including the identification table T3 of the third example (that is, the version is downgraded).

As shown in FIG. 6, information of the initialization range when the existing firmware has a newer version than the updated firmware is included in the identification table T3 of the third example. In the identification table T3 of the third example, “o” is assigned to the boxes of functions 4 and 5 in the column of version 11.0. Accordingly, when the version of the existing firmware is version 11.0, the control unit 30 executes initialization of functions 4 and 5 in the whole control information in the initialization executing step S50 and omits initialization of the other functions. In the identification table T3 of the third example, “o” is assigned to the box of restart in the column of version 11.0. Accordingly, when the version of the existing firmware is version 11.0, restart of the hard disk device 1 is executed in the restart executing step S70. As shown in the identification table T3 of the third example shown in FIG. 6, the identification table may include information of the initialization range when the version of the existing firmware is newer than the version of the updated firmware. In this case, it is possible to shorten the operation time even when the version of the firmware is downgraded.

The configurations and the operations and advantages of the hard disk device 1, the firmware update program, and the firmware update method according to the present embodiment will be summarized below.

As shown in FIG. 1, the hard disk device 1 according to the present embodiment includes the storage unit 20 and the control unit 30. The storage unit 20 stores firmware and control information of the firmware. The control unit 30 operates the firmware on the basis of the control information. As shown in FIG. 3, the control unit 30 is able to perform the reception step S10, the update step S30, the initialization range identifying step S41, and the initialization executing step S50. The reception step S10 is a step of receiving updated firmware from a computer 2. The update step S30 is a step of updating existing firmware with the updated firmware. The initialization range identifying step S41 is a step of identifying an initialization range of the control information. The initialization executing step S50 is a step of executing initialization of the control information in the initialization range when there is the initialization range. The updated firmware includes identification tables T1, T2, and T3 indicating the initialization ranges shown in FIGS. 4 to 6. The initialization range identifying step S41 is a step of identifying the initialization range on the basis of the identification tables T1, T2, and T3.

The firmware update program according to the present embodiment is a program for updating firmware stored in the storage unit 20 of the hard disk device 1. As shown in FIG. 3, the firmware update program causes the control unit 30 of the hard disk device to perform the reception step S10, the update step S30, the initialization range identifying step S41, and the initialization executing step S50. The reception step S10 is a step of receiving updated firmware from a computer 2. The update step S30 is a step of updating existing firmware with the updated firmware. The initialization range identifying step S41 is a step of identifying an initialization range of the control information of the firmware stored in the storage unit 20. The initialization executing step S50 is a step of executing initialization of the control information in the initialization range when there is the initialization range. The updated firmware includes identification tables T1, T2, and T3 indicating the initialization ranges shown in FIGS. 4 to 6. The initialization range identifying step S41 is a step of identifying the initialization range on the basis of the identification tables T1, T2, and T3.

The firmware update method according to the present embodiment is a method of updating firmware stored in the storage unit 20 of the hard disk device 1. As shown in FIG. 3, the firmware update method includes the reception step S10, the update step S30, the initialization range identifying step S41, and the initialization executing step S50. The reception step S10 is a step of receiving updated firmware from a computer 2. The update step S30 is a step of updating existing firmware with the updated firmware. The initialization range identifying step S41 is a step of identifying an initialization range of the control information of the firmware stored in the storage unit 20. The initialization executing step S50 is a step of executing initialization of the control information in the initialization range when there is the initialization range. The updated firmware includes identification tables T1, T2, and T3 indicating the initialization ranges shown in FIGS. 4 to 6. The initialization range identifying step S41 is a step of identifying the initialization range on the basis of the identification tables T1, T2, and T3.

With this configuration, the control unit 30 can omit some or all of initializations of the control information on the basis of the identification tables T1, T2, and T3. Accordingly, in comparison with a case in which the whole control information is initialized after firmware has been updated, it is possible to shorten a time required for updating the firmware. Since the identification tables T1, T2, and T3 are provided along with the updated firmware, the control unit 30 does not need to determine the initialization range through calculation. Accordingly, the control unit 30 can immediately identify the minimum initialization range. Since the initialization range is information which is provided from a provider, it is possible to guarantee operation reliability after the firmware has been updated.

In the hard disk device 1 according to the present embodiment, the identification tables T1, T2, and T3 shown in FIGS. 4 to 6 indicate the initialization range for each version of the existing firmware. The initialization range identifying step is a step of identifying the initialization range on the basis of the version information of the existing firmware acquired from the existing firmware and the identification tables T1, T2, and T3.

In the firmware update program according to the present embodiment, the identification tables T1, T2, and T3 shown in FIGS. 4 to 6 indicate the initialization range for each version of the existing firmware. The initialization range identifying step is a step of identifying the initialization range on the basis of the version information of the existing firmware acquired from the existing firmware and the identification tables T1, T2, and T3.

In the firmware update method according to the present embodiment, the identification tables T1, T2, and T3 shown in FIGS. 4 to 6 indicate the initialization range for each version of the existing firmware. The initialization range identifying step is a step of identifying the initialization range on the basis of the version information of the existing firmware acquired from the existing firmware and the identification tables T1, T2, and T3.

With this configuration, when the existing firmware has one of a plurality of versions, the identification tables T1, T2, and T3 provide an optimal initialization range for each of the plurality of versions. Accordingly, the control unit can immediately identify a minimum initialization range by acquiring the version information of the existing firmware.

In the hard disk device 1 according to the present embodiment, the identification tables T1, T2, and T3 shown in FIGS. 4 to 6 indicate whether restart is necessary for each version of the existing firmware. The control unit 30 can perform the restart necessity determining step S60 and the restart executing step S70. The restart necessity determining step S60 is a step of determining whether restart of the hard disk device 1 is necessary on the basis of the version information of the existing firmware acquired from the existing firmware and the identification tables T1, T2, and T3. The restart executing step S70 is a step of executing restart of the hard disk device 1 when it is determined in the restart necessity determining step S60 that restart is necessary.

In the firmware update program according to the present embodiment, the identification tables T1, T2, and T3 shown in FIGS. 4 to 6 indicate whether restart is necessary for each version of the existing firmware. The firmware update program causes the control unit 30 to perform the restart necessity determining step S60 and the restart executing step S70. The restart necessity determining step S60 is a step of determining whether restart of the hard disk device 1 is necessary on the basis of the version information of the existing firmware acquired from the existing firmware and the identification tables T1, T2, and T3. The restart executing step S70 is a step of executing restart of the hard disk device 1 when it is determined in the restart necessity determining step S60 that restart is necessary.

In the firmware update method according to the present embodiment, the identification tables T1, T2, and T3 shown in FIGS. 4 to 6 indicate whether restart is necessary for each version of the existing firmware. The firmware update method includes the restart necessity determining step S60 and the restart executing step S70. The restart necessity determining step S60 is a step of determining whether restart of the hard disk device 1 is necessary on the basis of the version information of the existing firmware acquired from the existing firmware and the identification tables T1, T2, and T3. The restart executing step S70 is a step of executing restart of the hard disk device 1 when it is determined in the restart necessity determining step S60 that restart is necessary.

With this configuration, the control unit 30 does not unnecessarily execute restart after the firmware has been updated. Accordingly, in comparison with a case in which restart is necessarily performed after firmware has been updated, it is possible to shorten a time required for updating the firmware. Since the identification tables T1, T2, and T3 are provided along with the updated firmware, the control unit 30 does not need to determine whether restart is necessary through calculation. Accordingly, the control unit 30 can immediately determine the restart necessity. Since information on whether restart is necessary is information which is provided from a provider, it is possible to guarantee operation reliability after the firmware has been updated.

In the hard disk device 1 according to the present embodiment, the initialization range identifying step S41 shown in FIG. 3 is a step of including the whole control information in the initialization range when the version of the existing firmware is newer than the version of the updated firmware.

In the firmware update program according to the present embodiment, the initialization range identifying step S41 shown in FIG. 3 is a step of including the whole control information in the initialization range when the version of the existing firmware is newer than the version of the updated firmware.

In the firmware update method according to the present embodiment, the initialization range identifying step S41 shown in FIG. 3 is a step of including the whole control information in the initialization range when the version of the existing firmware is newer than the version of the updated firmware.

With this configuration, when the version of the updated firmware is older than the version of the existing firmware (that is, when downgrade update is performed), it is possible to enhance operation reliability after the firmware has been updated by initializing the whole control information. In the initialization range identifying step S41, the control unit 30 may not necessarily compare the versions of the existing firmware and the updated firmware. For example, when it is recognized that the version of the existing firmware is not included in the identification tables T1, T2, and T3, the control unit 30 may determine that the version of the existing firmware is newer than the version of the updated firmware.

In the hard disk device 1 according to the present embodiment, as shown in FIG. 6, information on the initialization range when the version of the existing firmware is newer than the version of the updated firmware is included in the identification table T3.

In the firmware update program according to the present embodiment, as shown in FIG. 6, information on the initialization range when the version of the existing firmware is newer than the version of the updated firmware is included in the identification table T3.

In the firmware update method according to the present embodiment, as shown in FIG. 6, information on the initialization range when the version of the existing firmware is newer than the version of the updated firmware is included in the identification table T3.

With this configuration, when the version of the updated firmware is older than the version of the existing firmware (that is, when downgrade update is performed), it is possible to omit some or all initializations of the control information on the basis of the identification table T3. Accordingly, in comparison with a case in which the whole control information is initialized after the firmware has been updated, it is possible to shorten a time required for updating the firmware.

According to at least one of the aforementioned embodiments, it is possible to omit some or all initializations of the control information on the basis of the identification tables T1, T2, and T3 included in the updated firmware and to shorten a time required for updating the firmware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A hard disk device comprising:
a storage unit configured to store firmware and control information of the firmware; and
a control unit configured to operate the firmware on the basis of the control information,
wherein the control unit is configured to perform:
receiving updated firmware from a computer;
updating existing firmware with the updated firmware;
identifying an initialization range of the control information; and
executing initialization of the control information in the initialization range when there is the initialization range,
wherein the updated firmware includes an identification table indicating the initialization range, and
wherein the identifying the initialization range is to identify the initialization range on the basis of the identification table.

2. The hard disk device according to claim 1, wherein the identification table indicates the initialization range for each version of the existing firmware, and
wherein the identifying the initialization range is to identify the initialization range on the basis of version information of the existing firmware acquired from the existing firmware and the identification table.

3. The hard disk device according to claim 2, wherein the identification table indicates whether a restart is necessary for each version of the existing firmware, and
wherein the control unit is configured to further perform:
determining whether a restart of the hard disk device is necessary on the basis of the version information of the existing firmware acquired from the existing firmware and the identification table; and
restarting the hard disk device when it is determined in the restart necessity determining step that a restart is necessary.

4. The hard disk device according to claim 2, wherein the identifying the initialization range is to cause the whole control information to be included in the initialization range when a version of the existing firmware is newer than a version of the updated firmware.

5. The hard disk device according to claim 2, wherein the identification table includes information of the initialization range when the existing firmware has a newer version than the updated firmware.

6. A firmware update program for updating firmware stored in a storage unit of a hard disk device, the program causing a control unit of the hard disk device to perform:
receiving updated firmware from a computer;
updating existing firmware with the updated firmware;
identifying an initialization range of the control information of the firmware stored in the storage unit; and
executing initialization of the control information in the initialization range when there is the initialization range,
wherein the updated firmware includes an identification table indicating the initialization range, and
wherein the identifying the initialization range is to identify the initialization range on the basis of the identification table.

7. The firmware update program according to claim 6, wherein the identification table indicates the initialization range for each version of the existing firmware, and
wherein the identifying the initialization range is to identify the initialization range on the basis of version information of the existing firmware acquired from the existing firmware and the identification table.

8. The firmware update program according to claim 7, wherein the identification table indicates whether a restart is necessary for each version of the existing firmware, and
wherein the control unit is caused to further perform:
determining whether a restart of the hard disk device is necessary on the basis of the version information of the existing firmware acquired from the existing firmware and the identification table; and
restarting the hard disk device when it is determined in the restart necessity determining step that a restart is necessary.

9. The firmware update program according to claim 7, wherein the identifying the initialization range is to cause the whole control information to be included in the initialization range when a version of the existing firmware is newer than a version of the updated firmware.

10. The firmware update program according to claim 7, wherein the identification table includes information of the initialization range when the existing firmware has a newer version than the updated firmware.

11. A firmware update method of updating firmware stored in a storage unit of a hard disk device, the firmware update method comprising:
receiving updated firmware from a computer;
updating existing firmware with the updated firmware;
identifying an initialization range of the control information of the firmware stored in the storage unit; and
executing initialization of the control information in the initialization range when there is the initialization range,
wherein the updated firmware includes an identification table indicating the initialization range, and
wherein the identifying the initialization range is to identify the initialization range on the basis of the identification table.

12. The firmware update method according to claim 11, wherein the identification table indicates the initialization range for each version of the existing firmware, and
wherein the identifying the initialization range is to identify the initialization range on the basis of version information of the existing firmware acquired from the existing firmware and the identification table.

13. The firmware update method according to claim 12, wherein the identification table indicates whether a restart is necessary for each version of the existing firmware, and
wherein the firmware update method further comprises:
determining whether a restart of the hard disk device is necessary on the basis of the version information of the existing firmware acquired from the existing firmware and the identification table; and
restarting the hard disk device when it is determined in the restart necessity determining step that a restart is necessary.

14. The firmware update method according to claim 12, wherein the identifying the initialization range is to cause the whole control information to be included in the initialization range when a version of the existing firmware is newer than a version of the updated firmware.

15. The firmware update method according to claim 12, wherein the identification table includes information of the initialization range when the existing firmware has a newer version than the updated firmware.
